(19) United States
(12) Patent Application Publication
(10) Pub. No.: US 2007/0004342 A1
(43) Pub. Date: Jan. 4, 2007

(54) Data collection and remote control module and method

(76) Inventors: Marlon Z. Kasprzyk, Winfield, IL (US); Kazimierz G. Wardawy, Bloomingdale, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/235,043

(22) Filed: Sep. 26, 2005

Related U.S. Application Data
(60) Provisional application No. 60/696,351, filed on Jul. 1, 2005.

(51) Int. Cl. H04B 17/00

(52) U.S. Cl. 455/67.11; 455/12.1

(57) ABSTRACT

An interface system and method are provided for communication between an apparatus and a remote base station using an established wireless network. The system comprises a data collection module configured to receive data relating to a characteristic of the apparatus. The data collection module comprises a port connected to the data collection module for coupling the data collection module to a portable communication device configured for wireless communication over the established wireless network. The data collection module further comprises a controller configured to transmit a message in response to the received data, wherein the message is transmitted to the remote base station via the port and the portable communication device. The controller can also be used to control aspects of the apparatus in response to instructions received from the remote base station via the portable communication device and the established wireless network.

### CROSS-REFERENCE TO RELATED APPLICATIONS

This application claims the benefit of U.S. Provisional Patent Application No. 60/696,351, filed Jul. 1, 2005, which is incorporated herein by reference and made a part hereof.

### TECHNICAL FIELD

The invention generally relates to a real-time data collection and remote control monitoring and data collection module and to a method of using the module. More particularly, the invention relates to an interface system for communication between an apparatus and a remote base station using an established wireless network.

### BACKGROUND OF THE INVENTION

Portable communication devices are widely known and popular in the market. Such devices are ubiquitous, generally affordable and highly used. In fact, portable, wireless communication has emerged as a major field of product research and development.

One example of a portable communication device is a cellular phone. Cellular phones communicate over established cellular phone networks. Such networks comprise switching servers that route data to and from predetermined addresses corresponding to the cellular phone devices. High-powered antennas operate to send and receive the data from the cellular phones, and communicate with the switching servers either by wire (e.g., through cable, such as fiber-optic cable), or wirelessly through satellite communication.

Some portable communication devices communicate with satellite networks directly, such as satellite phones, global positioning devices and high-powered radio frequency communication devices. Those devices are infrequent in the consumer market, however, because the cost of their manufacture, and subsequent sale price, are prohibitively high for the average consumer.

Some portable communication devices allow for the receipt of data that is not in the form of an open-channel audio connection such as a phone call. For example, some cellular phones are equipped with software to decode a received data packet into an alphanumeric text message, an electronic mail or limited audiovisual information from the Internet. Most personal communication devices, however, do not allow for the receipt of an open “data call”, i.e., a request for an open data connection from a remote location. As a consequence, most portable communication devices cannot be used to establish an on-demand data connection with a remote location. It is therefore not currently possible to use such devices as a means for the transfer of data from a remote source. Parties seeking a cost-effective means to remotely monitor and control equipment and devices are therefore unable to turn to existing portable communication devices or their networks as a solution. Instead, such parties must turn to the more expensive satellite control systems, or other more expensive proprietary control systems, including the egregiously expensive modification of an existing cellular phone network as described in U.S. Patent Application Publication No. 2002/0077114. Therefore, a need has arisen for an interface system for communication between an apparatus and a remote base station using an existing wireless network.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

An interface system for communication between an apparatus or system and a remote base station, using an established wireless network, is provided. The system comprises a data collection module configured to receive data relating to a characteristic of the apparatus. The data collection module comprises a port connected to the module for coupling the module to a portable communication device, wherein the portable communication device is configured for wireless communication over the established wireless network. The data collection module further comprises a controller configured to transmit a message in response to the received data, wherein the message is transmitted to the remote base station via the port and the portable communication device. Although referred to as a “data collection module,” the module also can provide control and real-time monitoring functions in certain embodiments as described herein.

According to one embodiment, the portable communication device is a cellular phone. In another embodiment, the portable communication device is configured to establish communication with the remote base station, via the established wireless network, according to a predetermined time interval. In another embodiment, the portable communication device is configured to receive a signal from a second remote location, and in response thereto, establish communication with the remote base station via the established wireless network. Optionally in that embodiment, the signal received from the second remote location contains a predetermined code.

In yet another embodiment, the data collection module is used to control an aspect of the apparatus. In this capacity, the data collection module is configured to receive a first signal from the remote base station, via the port and the portable communication device, and in response thereto, transmit a second signal (i.e., a control signal) to the apparatus or a component thereof. Optionally, the apparatus has a plurality of states, and the second signal is for changing the state of the apparatus.

In yet another embodiment, the data collection and real-time monitoring module further comprises a port connected to the data collection module for coupling the module with the apparatus. The message transmitted by the data collection module comprises data representative of a characteristic of the apparatus. Additionally, the data collection module further comprises an activator for activating a solenoid, wherein the solenoid is for executing a functionality of the portable communication device. The data collection module can also comprise an indicator for indicating a status of at least one of the data collection module, the apparatus, the portable communication device and the established wireless network.

According to yet another embodiment, a method for communicating between an apparatus and a remote base station using an established wireless network is also provided. The method comprises the step of receiving data relating to a characteristic of the apparatus at a data collection module. In response to receipt of the data, the method includes the step of transmitting a message from the data collection module to the remote base station via a portable communication device configured for wireless communication over the established wireless network.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a diagram illustrating an overview of a system for remote communication with a device configured in accordance with the principles of the present invention;

FIG. 2 is the first part of a flowchart illustrating one embodiment of a method for communicating with a remote device in accordance with the principles of the present invention;

FIG. 3 is the second part of a flowchart illustrating one embodiment of a method for communicating with a remote device in accordance with the principles of the present invention;

FIG. 4 is a diagram illustrating the operation of a data collection module system for remote monitoring and operation of a vehicle, configured in accordance with the principles of the present invention;

FIG. 5 is an illustration of a modem operably coupled to a control module for use in a system for remote communication with a device;

FIG. 6 is a diagram illustrating a portable communication device and port for use with a data collection module configured in accordance with the principles of the present invention;

FIG. 7 is a diagram of a system for remote authorization of hazardous materials distribution for use with a data collection module configured in accordance with an embodiment of the present invention;

FIG. 8 is a side view of a personal communication device configured in accordance with one aspect of the present invention;

FIG. 9 is an aerial view of a personal communication device configured in accordance with one aspect of the present invention;

FIG. 10 is a view of an exterior wall of a housing for the components for a system for remote communication with a device according to the present invention;

FIG. 11 is a diagram of a system for remote monitoring and control of a healthcare apparatus, for use with a data collection module configured in accordance with an embodiment of the present invention; and,

FIG. 12 is a diagram of a data collection module for a remote healthcare monitoring system configured in accordance with the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

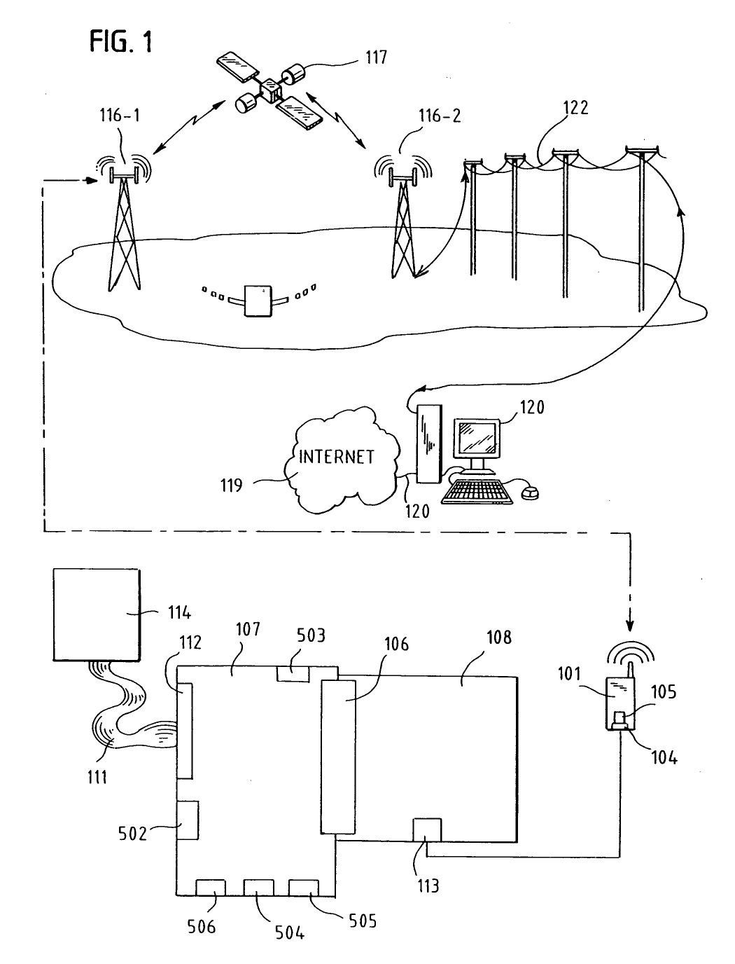

Referring initially to FIG. 1, there is illustrated an overview diagram for an interface system for communication between an apparatus 114 and a remote base station 121 over an established wireless network 115. The interface system includes a data collection module 107 which is configured to receive data relating to a characteristic of the apparatus 114. A port 106 is connected to the data collection module 107 for coupling the data collection module 107 to a portable communication device 101 configured for wireless communication over the established wireless network 115.

In a preferred embodiment, the mobile communication device 101 is a cellular phone. Examples of portable communication devices practicable with the present invention include not only cellular phones, but also personal digital assistants (PDAs), wireless alphanumeric devices such as pagers, wireless data transmission devices such as portable electronic mail devices and wireless-enabled mobile personal computers.

Regardless of the specific embodiment of the portable communication device 101, such devices typically comprise a microprocessor, a memory, a receiver/transmitter 102, and a port 104. The strength of the signals received by and transmitted from the portable communication device 101 depends on the signal strength of the receiver/transmitter 102, which is typically dependent on the amplifier and other antenna components disposed within the portable communication device 101. It will be understood that dependent on the type of portable communication device 101, the size and type of the port 104 will vary.

Data signals representative of the portable communication device's operation are transmitted from port 104 in the portable communication device 101 through a communication link 103. Such data signals include the state of the device 101, the signals transmitted from the device 101, and the signals received by the device 101. Those data signals can be communicated from the portable communication device 101 to the data collection module 107 via the port 106 in the data collection module 107. Port 106 therefore operates as a means for monitoring the status and behavior of the portable communication device 101, and also for controlling and programming the device 101. Port 106 can be embodied in a cable or wire connection 106 as illustrated, but can also be embodied in any connection capable of transmitting such signals; for example, a wireless connection such as Bluetooth or WiFi.

Data signals transmitted through port 106 are preferably received by modem 105, which is a component of portable communication device 101 in a preferred embodiment. Modem 105 will be understood by one of skill in the art to comprise a microprocessor and/or controller and memory for executing the industry-standard modem “AT” command set developed by Hayes and standardized as command set TIA-602. Alternatively, modem 105 includes memory and electrical architecture for executing an extended modem command set standardized in ITU-T recommendation V.250, i.e. V.25ter. Modem 105 receives data transmissions from portable communication device 101 and translates those transmissions into modem-acceptable data. Conversely, modem 105 can be configured to transmit data to portable communication device 101 using the modem command set stored in modem 105. Such data can then be transmitted by portable communication device 101 to the established wireless network 115.

In a preferred embodiment, data collection module 107 interfaces to a microprocessor board controller 108 via interface port 106. Data collection module 107 preferably comprises power input 502, port 112 and diagnostic switches interface 503. Diagnostic switches interface 503 is provided for installing and providing service to controller 108. Further, the data collection module 107 comprises diagnostic indicator (e.g., light-emitting diodes) ports 504, 504 as well as the communication device power activation solenoid, and power connector 506. Controller 108 communicates with apparatus 114 via port 106, data collection module 107, port 112 and data cable arrangement 111. As illustrated in FIG. 5, port 112 is in one embodiment electrically hard-wired to the data collection module 107. Alternatively, port 112 may be a wired or wireless connection, so long as data communication is facilitated between apparatus 114 and controller 108. The controller 108 is preferably comprised of standard microprocessor board components such as those available from Microsoft Corporation and Intel Corporation.

The data collection module 107 is connected directly to or otherwise coupled with the apparatus 114. The data collection module 107 is configured to received data regarding a characteristic of the apparatus 114 and to relay information to a remote base station 121 via the portable communication device 101 responsive to the received data. The characteristic of the apparatus 114 can be any sensed input relating to a state, function or status of the apparatus 114. Sensors and/or the input devices coupled to or incorporated in the apparatus 114 can be used to provide the data to the data collection module 107.

One example of an apparatus 114 that can be used with the present invention is a vehicle with an on-board diagnostic system. The on-board diagnostic system can be configured to transfer data to the data collection module 107 through the port 112, as described above, wherein the data is representative of a characteristic of the apparatus 114; e.g., the temperature of the engine or diagnostic codes. In response to that data, the controller 108 transmits a message to the remote base station 121 via the established wireless network 115. In a preferred embodiment, the message communicated from the data collection module 107 to the remote base station 121 contains data representative of the characteristic of the apparatus 114. For example, if the characteristic is the temperature of an engine, the message transmitted by the data collection module 107 to the remote base station 121 contains data representing the temperature of the engine. It will be understood that the message transmitted by the data collection module may be precisely the same as the data received from the apparatus 114, or some other data or instructions responsive to or based on the sensed data. For example, if the temperature is received in human-readable form, the data collection module 107 may simply forward that exact data to the remote base station 121. In that event, the data received and the message transmitted are exactly identical. However, the data received by the data collection module 107 may be formatted so as to be human-readable, or may be provided amongst other information; in that event, the data received and the message transmitted are not identical, but are both representative of the characteristic of the apparatus 114. It should be understood that in a similar way, data can be sent to apparatus 114 thereby providing control stimulus for apparatus 114.

The message is transmitted from the data collection module 107 to the remote base station 121 via the port 112 and the portable communication device 101 over the established wireless communication network 115. It will be understood that a wide variety of established wireless networks 115 can be used with the present invention, including a cellular phone network as illustrated, a cellular digital packet data (CDPD) network, a high speed circuit switched data (HSCSD) network, a packet data cellular (PDC-P) network, a general packet radio service (GPRS) network, a 1× radio transmission technology (1×RTT) network, a Bluetooth network, an infrared (IrDA) network, a multichannel multipoint distribution service (MMDS) network, a local multipoint distribution service (LMDS), a wireless high fidelity (WiFi) network and a radio frequency network.

As illustrated in FIG. 1, a wireless cellular network comprises various components such as receiver towers 116, routers/switches 118 and satellites 117. Typically, a portable communication device 101 such as a cellular phone is in communication with a cellular receiver 116-1, commonly referred to as a “tower”, because the receiver is typically located at a relatively high altitude, e.g. 100 feet. The receiver 116-1 is in communication with other receivers, e.g. receiver 116-2, on the network, via wireless communication such as via satellite 117, or through a wired connection such as a router/switch 118.

Messages transmitted via the established wireless network 115 are transmitted to a predetermined address, such as a telephone number or internet protocol (IP) address. The established wireless network 115 comprises hardware and software, e.g. router/switch 118, for routing the message to modules corresponding to predetermined addresses. In the preferred embodiment of the present invention, both the portable communication device 101 and the remote base station 121 have predetermined addresses. The message transmitted from the data collection module 107 is thus transmitted to the predetermined address of the remote base station 121, and the routing and switching elements of the established wireless network 115 (e.g., router/switch 118) route the message to the predetermined address of the remote base station 121.

In a preferred embodiment, the established wireless network 115 is in communication with the Internet 119, through an interface such as the router 118, thereby allowing the message transmitted from the data collection module 107 to be transmitted to a station 121 connected to the Internet 119 or wired telephone line 122. As illustrated in FIG. 1, the remote base station 121 is a computer. In that embodiment, the message is therefore transmitted from the data collection module 107, via the port 112 and portable communication device 101, to the established wireless network 115, and is received at the remote base station 121 from the Internet 119 or wired telephone line 122.

Referring now to FIG. 4, in an exemplary embodiment remote base station 121 is a personal computer located at an automobile service station. The apparatus 114 is an automobile engine located in vehicle 401, having a characteristic representing, for example, the temperature of the engine 114. In this embodiment, the portable communication device 101 is a cellular phone, placed in communication with the data collection module 107 via the port 112. The data collection module 107 is in communication with the engine apparatus 114. Data from the engine 114 is received by the controller 108 of the data collection module 107. The controller 108, in response to the receipt of the data, transmits a message via the port 106 and the cellular phone 101 to an established wireless cellular phone network 115. The network 115 is in communication with the Internet 119 and/or wired telephone line 122, to which a remote service base station computer 121 is connected. The message transmitted from the data collection module 107 is thereby communicated to the remote base station 121.

The present system can also be utilized to control aspects of the apparatus from the remote base station 121. In a preferred embodiment, the data collection module 107 is configured to receive a first signal from the remote base station 121, via portable communication device 101 and ports 104, 604. In response to the first signal, the data collection module 107 can then transmit a second signal (e.g., a control signal) to the apparatus 114. It will be understood that this embodiment is essentially the reverse of the aforementioned system of transmitting a message in the opposite direction. Referring again to the automobile service station embodiment, a user (e.g., a mechanic) of the personal computer remote base station 121 at an automobile service station can transmit a first signal to the cellular phone 101 via the Internet 119 and/or wired telephone line 122 and established wireless cellular phone network 115. The first signal is then communicated to the data collection module 107 via the port 604. In response to receiving the first signal, the data collection module 107 then transmits a second (e.g., control) signal to the engine apparatus 114. The first and second signals can include more than one instruction or set of data depending on the apparatus and characteristic or control function at issue.

The apparatus 114 preferably has a plurality of states, and a signal received from the remote base station (i.e., the second signal) is for changing a state of the apparatus. The second signal received by the data collection module 107 from the remote base station 121 is, in this embodiment, for changing a state of the apparatus.

For example, in certain types of automobiles, when the temperature of the automobile engine surpasses a predetermined threshold, a microprocessor embedded within the vehicle electrically disables the automobile, and the vehicle shuts down. A driver in that situation can use the data collection module 107 of the present invention, in communication with the driver's cellular phone 101, to transmit a message to a remote base station 121 at an automobile service center, wherein the message reflects the temperature of the engine 114, and further can reflect that the driver's vehicle has been electrically disabled. The remote base station 121 at the service center can then transmit a first signal to the cellular phone 101, which is received by the data collection module 107. In response to that first signal, the data collection module 107 transmits a second control signal to the engine 114, wherein the control signal is operative to re-engage the vehicle and thereby allow the driver to drive the vehicle to a service station.

In a preferred embodiment, the portable communication device 101 is configured to establish communication with the remote base station 121, via the established wireless network 115, according to a predetermined time interval based on a time interrupt. A time interrupt is a device used in both hardware and software to initiate or terminate an operation at a predetermined time, commonly used to program and operate electrical devices such as personal computers and cellular phones. For example, the portable communication device 101 can be programmed to establish communication with the remote base station 121 every 60 minutes, or once per day. In the embodiment described above, a cellular phone 101 can thus be used to transmit the temperature of a vehicle engine 114 to the remote base station 121 once per hour, automatically. The predetermined time interval is a variable, and can therefore be programmed to any value desirable by the user of the present invention. The time interrupt can be used to not only initiate communication, but also to establish electrical connections within a device. Thus, the time interval may also be used to first turn on the portable communication device 101, then establish communication with the remote base station 121. Lastly, the time interrupt can be used to turn off the portable communication device 101, thereby saving valuable battery life of the portable communication device 101.

In another embodiment, the portable communication device 101 is configured to receive a signal from a second remote location, and in response thereto, establish communication with the remote base station 121 via the established network 115. This feature allows for “remote control” of the functionality of the data collection module 107. The portable communication device 101 is configured to receive a signal from a second remote location; for example, if the portable communication device 101 is a cellular phone, the device 101 can receive a phone call from another telephone at a second remote location. Upon receipt of the signal from the second remote location, the portable communication device 101 establishes communication with the remote base station 121.

In an exemplary embodiment, the data collection module 107 is in communication with a security apparatus 114 installed in a home, such as an electric lock. A portable communication device 101 is in communication with the data collection module 107. A remote base station 121 such as a personal computer is in communication with the established wireless network 115. A user at a second remote location, such as a commercial office telephone, transmits a first signal to the portable communication device 101 at the home, and in response thereto, the portable communication device transmits a second signal to the remote base station 121. For example, a homeowner using a telephone at his work (a second remote location) can thereby transmit the status of his home security system to a computer located at a security company (the remote base station). For example, a security company can lock the door of a house if the house owner forgot to do so. Similarly, the heat for the house may be remotely turned on or off when the owner is on vacation. The air conditioning at a cottage, for example, can be activated remotely prior to the owner's arrival.

The signal received from the second remote location is preferably a predetermined code, such as a predetermined ring tone, or touch-tone code sequence. In that embodiment, the second signal is transmitted from the portable wireless communication device 101 to the remote base station 121 only upon receipt of the predetermined code as a part of the signal from the second remote location. This feature provides a degree of security to the remote functionality of the data collection module 107, i.e., before transmitting a signal to the remote base station 121, the predetermined code is required from the second remote location. The controller 108 of the data collection module can be programmed to recognize a touch-tone code sequence, or to discern a unique ring tone such as a square wave. The predetermined code may also correspond to the address of the second remote location, for example, a phone number from which the signal is received. In that embodiment, the portable communication device 101 receives a signal from a second remote location, wherein the signal includes the address (e.g., a telephone number) of the second remote location. In response to the signal, comprising the predetermined code, the portable communication device 101 establishes communication with the remote base station 121.

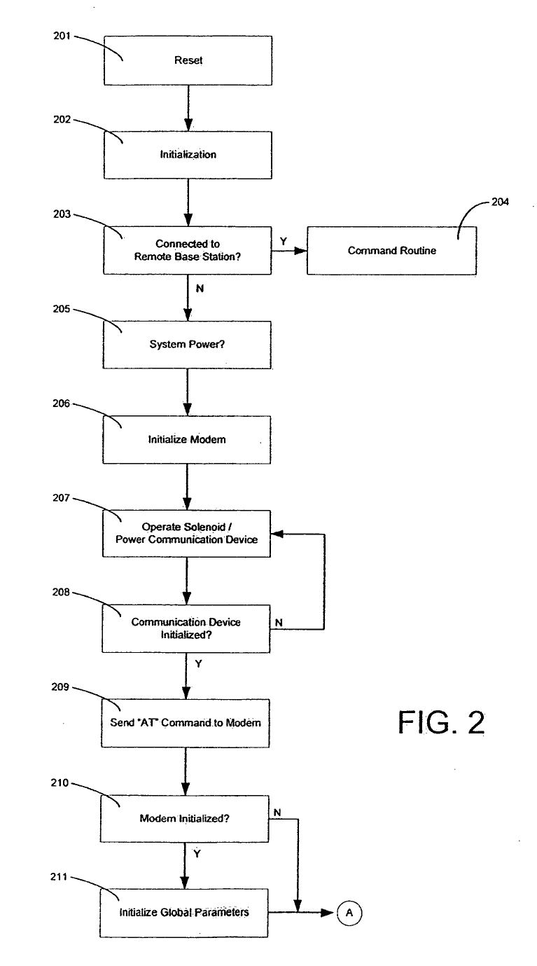

Referring now to FIG. 2, there is illustrated the first portion of a flowchart showing the operation of a data collection module configured in accordance with the principles of the present invention. At step 201, the system is reset, which can be initiated either by providing initial power to the data collection module 107 or by resetting the data collection module 107. In either event, upon initialization, the data collection module routine begins at step 201. At step 202, the software and hardware variables, ports and timers are initialized. At step 203, the software checks to see if a connection is made with the remote base station. The software performs that check by analyzing a variable, a flag, which is set “high” when a connection is made with the remote base station, and is set “low” when that connection is not made. If the data collection module is in communication with the remote base station (i.e., the variable flag indicating that connection is set to “high”), then the routine proceeds to step 204, which is a line-by-line receipt of commands and the performance of those commands.

At step 204, commands can be received from the data collection module 107 itself, such as from an application (e.g., computer program) stored in the memory of the module. That application can, for example, be for receiving data from the apparatus and in response thereto transmitting a message to the remote base station. At step 204, commands can be received from the remote base station, such as a request for the status of the apparatus, or a command to change the state of the apparatus. In response thereto, the data collection module can transmit a signal to the apparatus to perform the requested function. Step 204 is a generalization of the routine to receive line-by-line commands from a source and execute those commands according to the software and hardware functionality provided to the routine, as will be understood by one of skill in the art. After the performance of step 204 (i.e., after the execution of the application-specific functionality), the routine returns to step 203.

If at step 203 it is determined that the data collection module is not in communication with the remote base station (i.e., the variable flag indicating such status is set to “low”), the routine proceeds to step 205, in which it determines whether the components of the data collection module have been “powered on”, meaning that those components have been initialized and are operating properly. The “power on” status is indicated by a variable flag, which is set to “high” if the system is correctly powered on, and set to “low” if the system is not. If it is determined at step 205 that the system is powered on, the routine proceeds to step 301, discussed below. If it is determined in step 205 that the system is not powered on, the routine proceeds to steps 206 through 211 to appropriately power on the components of the data collection module. At step 206, the system provides power to its communication component, which in a preferred embodiment comprise a modem and the modem's attendant electrical hardware components. At step 207, the system provides power to the portable communication system.

In one embodiment of step 207 and as illustrated in FIG. 13, the portable communication system is automatically initialized by the operation of a solenoid 1301 to provide power to the portable communication system, which in the illustrated embodiment is a cellular phone 803. The solenoid 802 is activated by the data collection module, thereby initializing the cellular phone 803, and drawing electrical power to the cellular phone 803 through electrical power input line 801. Referring to FIG. 9, an alternate view of that embodiment is illustrated, showing the cellular phone 803 in the “open” position and providing a view of the cellular phone's “power on” button 901, which is activated by the solenoid 1302. This feature allows the portable communication device to be turned on and off by the data collection module automatically and without human interaction.

Referring again to FIG. 2, the data collection module routine at step 208 determines whether the portable communication device has been appropriately powered on, by querying the communication line from the portable communication device. If a signal is received indicating that the portable communication device is active, the portable communication device has been turned on. If no signal is received in response to the query, the portable communication device has not been properly turned on. At step 209, the routine queries the status of its communication component, preferably a modem, and at step 210, determines whether the communication component has been properly initialized and powered on. If at steps 208 or 210 the routine determines that the components have not been properly initialized, the routine returns to step 205 and thereby, if necessary, re-initiates the procedure for providing electrical power to the components of the system. If at steps 208 and 210 the routine determines that the components have been properly powered on and initialized, the routine proceeds to step 301.

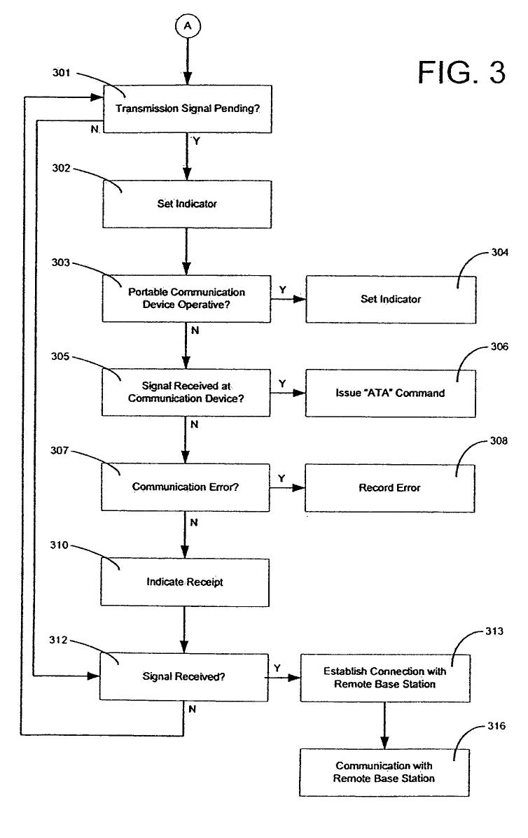

Referring now to FIG. 3, the second portion of a flowchart is illustrated for a routine operating a data collection module configured in accordance with the principles of the present invention. At step 301, the system determines whether a transmission is pending at the portable communication device. In a preferred embodiment, such a transmission is pending upon the receipt of a signal by the portable communication device from a remote location. If it is determined that such a transmission is not pending, the routine proceeds to step 312, discussed hereinafter. If it is determined at step 301 that a transmission is pending, the routine proceeds to step 302, where an indicator is set to indicate the communication status of the data collection module.

In one embodiment of step 302, and as illustrated in FIG. 10, a data collection module 1000 is shown having an indicator 1001 for indicating a status of at least one of the data collection module 1000, the portable communication device 1002, the established wireless network 115, the apparatus 114 and the remote base station 121. As illustrated in FIG. 10, there are a plurality of such indicators 1001 in a preferred embodiment. An electronically-operated light bulbs such as an LED can be used as the indicator 1001. The indicator 1001 can comprise a liquid crystal display screen, an audio indication system such as a speaker or a data output. Also illustrated in FIG. 10 is a portable communication device 1002 embedded within the data collection module 1000. In a preferred embodiment, the portable communication device 1002 is releasably placed in communication with the data collection module 1000 as described herein; in the illustrated embodiment, the portable communication device is an interior component of the data collection module 1000.

Referring again to FIG. 3, the routine at step 303 determines whether the portable communication device is operating. If a positive determination is made, the routine at step 304 preferably provides an indicator of the status of the portable communication device as described herein. At step 305, the routine determines whether a signal is being received by the portable communication device. If a signal is being received, the routine at step 306 instructs the portable communication device to receive the signal, and sets a variable flag indicating the receipt of a signal to “high”. After the signal is received at step 306, or if there is no signal being received at step 305, the routine at step 307 checks its communication component and if necessary, at step 308, records the existence of an error. At step 310, the routine indicates, via an indicator, that the receipt of a transmission by the portable communication device has ended.

At step 312, the routine determines whether a signal has been received by the portable communication device, by consulting the variable flag set to “high” at step 306. If that flag has been set to “high”, the routine at step 313 initiates contact with the remote base station and then, at step 316, communicates data to and preferably receives data from the remote base station. If at step 312 it is determined that no signal has been received by the portable communication device, the routine returns to step 301 to await the receipt of a signal.

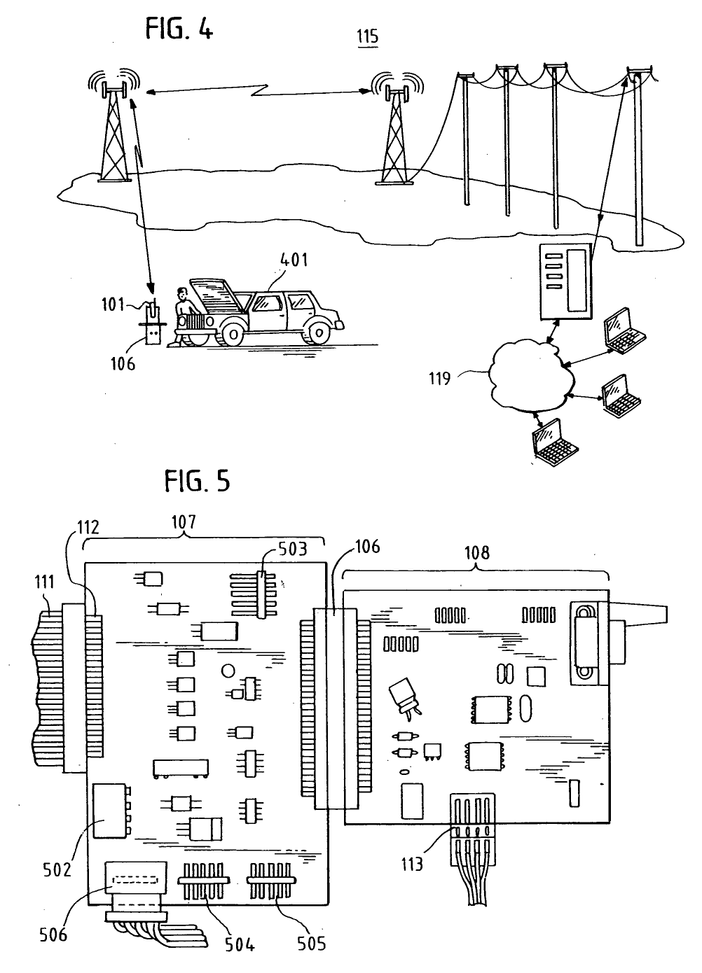

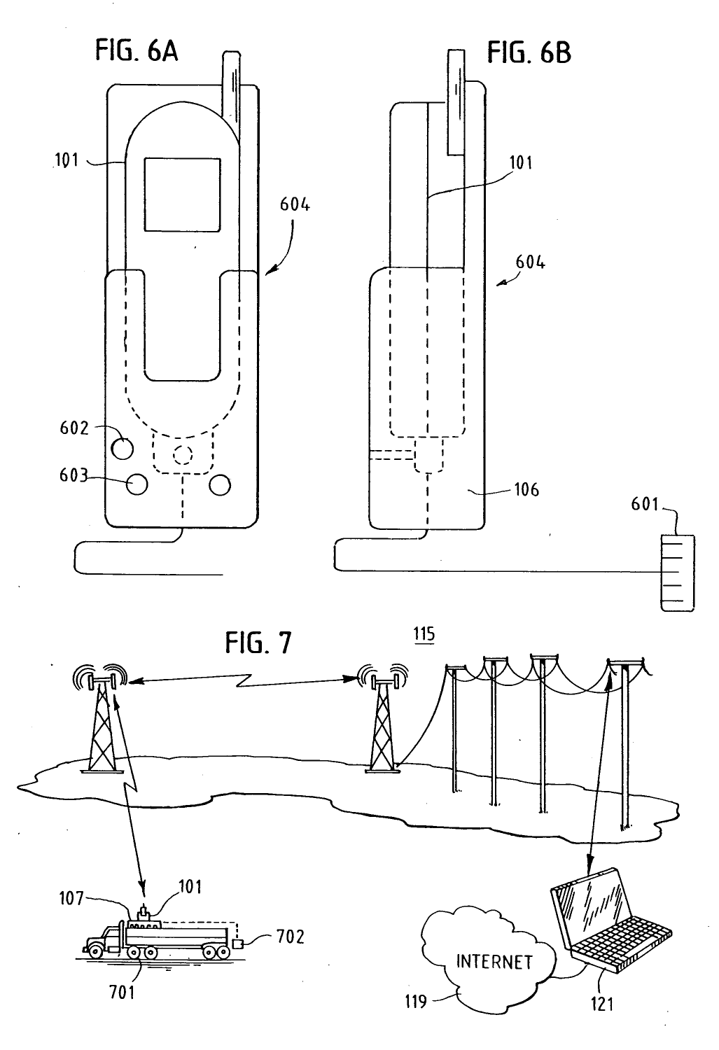

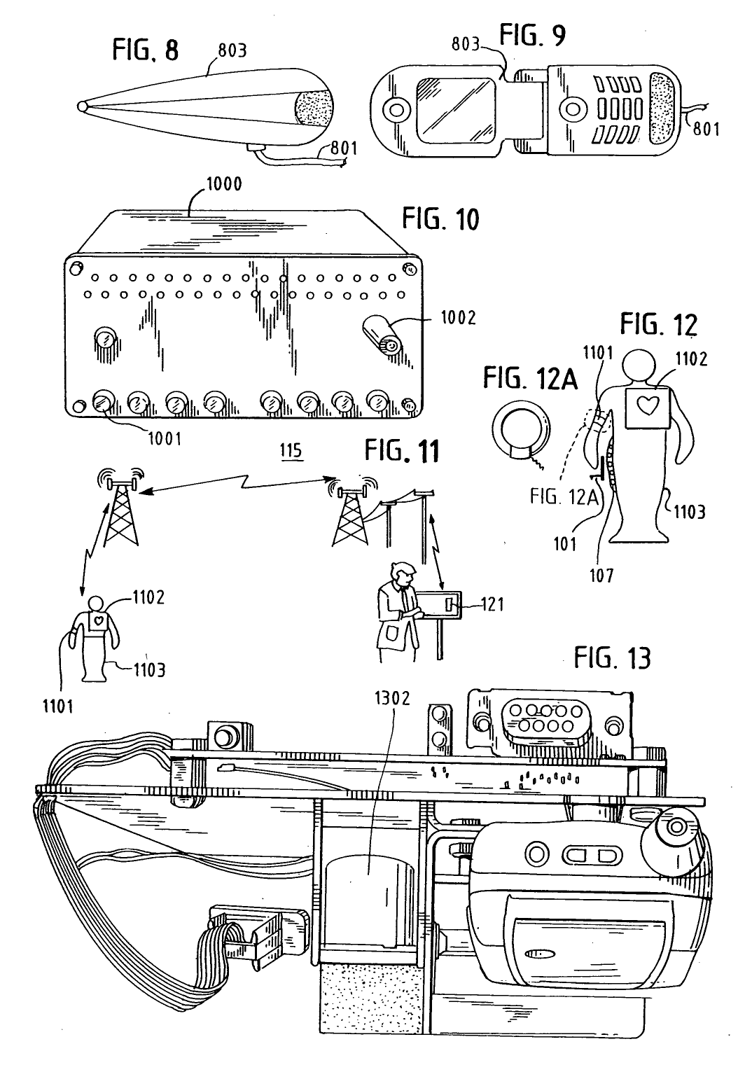

Referring now to FIG. 6, a portable communication device 101 is shown in communication with a port 604 for use with the present invention. In this embodiment, portable communication device 101 is a cellular phone, which is releasably coupled to port 604. The port 604 is a cellular phone “cradle” familiar to one of skill in the art. Cradle 604 is configured for communication with the data collection module 107 either wirelessly as described above with respect to port 604, or as illustrated, via wired connection 601. Link 601, whether wired or wireless, allows for the cellular phone 101 and its cradle 604 to be located remotely from the data collection module 107. In the automobile embodiment described above, data collection module can thus be located within the vehicle's engine compartment or transmission compartment, while port 604 and cellular phone 101 are situated more conveniently, such as on the dashboard of the vehicle.

Cradle 604 also preferably comprises a start button 602 for initiating communication between cradle 604 and data collection module 107. Start button 602 can also be used to provide electrical power to cellular phone 101. Other functionality can also be assigned to start button 602, such as initiating communication between data collection module 107 and remote base station 121, and initiating data collection module 107 to poll apparatus 114 for data representing a characteristic of the apparatus 114. Cradle 604 also preferably comprises indicator 603, for indicating a status of at least one of the data collection module 107, the cradle 604, the apparatus 114, the established wireless network 115, and the cellular phone 101. Cradle 604 can be used to provide electrical power to cellular phone 101 while cellular phone 101 is being used in communication with data collection module 107, so as to preserve the valuable battery life of the cellular phone 101. Cradle 604 can be used to provide electrical power to cellular phone 101 even when cellular phone 101 is not in communication with data collection module 107.

Referring now to FIG. 7, there is illustrated a diagram showing a system for the remote authorization of hazardous materials distribution, configured in accordance with the principles of the present invention. A vehicle 701 such as a tanker contains hazardous materials, which will be understood by one of skill in the art as requiring authorization prior to distribution, such as nuclear or biohazard waste. Apparatus 114 in this embodiment is a remotely-controlled dispensing valve 702, which is in communication with data collection module 107 aboard the vehicle 701. A portable communication device such as a cellular phone 101 is in communication with the data collection module 107, wherein the cellular phone 101 is in communication with an established wireless cellular phone network 115. The network 115 is in communication with the Internet 119 and/or wired telephone line 122, which is in communication with the remote base station 121. In this embodiment, remote base station 121 is a personal computer, wherein the user of the computer is a party with authority to authorize the distribution of the hazardous materials from vehicle 701.

Many cellular phones 101 available today comprise a digital camera, which can capture an image and save that image in the memory of the phone 101 and/or transmit the image over the established wireless network 115. The present invention takes advantage of this functionality of the cellular phone 101. Specifically, the cellular phone 101 can be used to capture an image of the location of vehicle 701, and can be used with data collection module 107 to transmit a message comprising image via established wireless network 115 to remote base station 121. The user at the remote base station 121 can thereby view the image, and if the image meets with the user's approval as to the location of the materials distribution, the user can transmit a signal in response to the message, via established wireless network 115, to the data collection module 107. The module 107 can then transmit a second signal to the apparatus 114, which is the remotely-controlled dispensing valve 702. The remote user at remote base station 121 can thereby authorize the distribution of hazardous materials, without requiring the user of vehicle 701 to be a party with authority to authorize the distribution.

In addition to the remote authorization of materials distribution, the data collection module 107 can also be used to remotely monitor assets. A cellular phone 101 with a built-in camera can capture an image and can be used to transmit that image via the established wireless network 115. The data collection module 107 can instruct the cellular phone 101 to regularly capture an image of a remote asset, such as a valuable painting or other cargo. The image is received at the remote base station 121 and viewed by a user, who can thereby be assured of the existence of the asset. The cellular phone 101 and/or data collection module 107 can also be coupled with a global positioning system (GPS), and can be configured to transmit GPS location data to the remote base station 121 as well as the image of the asset. Those two data, in combination, can provide a user at the remote base station 121 that the asset exists, and that it exists at the reported location.

Referring now to FIG. 11, there is illustrated a diagram for the remote monitoring of patients and the remote dispensing of medication for use with a data collection module configured in accordance with the principles of the present invention. In this embodiment, two examples of apparatus 114 are illustrated: The first is a medical monitoring instrument 1102 such as a blood pressure or blood glucose monitoring system, and the second is a medication dispensing system 1103 such as an intravenous liquid medication dispenser. The monitor 1102 and the dispenser 1103 are both in communication with the data collection module 107, which is outfitted to be comfortably worn by patient 1103. Data collection module 107 is in communication with a portable communication device 101 such as a cellular phone. Data such as the blood pressure of patient 1103 is received from the monitor 1102 by the data collection module 107, and in response thereto, data collection module transmits a message via the cellular phone 101 to the established wireless network 115. That message is received by remote base station 121 via the Internet 119 and/or wired telephone line 122. In this embodiment, remote base station 121 is a patient monitoring system, such as a medical computer configured to translate the message into data representing a characteristic of the patient; in this example, the characteristic is the patient's blood pressure. In response to the information received from the data collection module 107, a user of the remote base station 121 (such as a doctor or other trained medical personnel) can transmit a signal via the Internet 119 and/or wired telephone line 122 and the established wireless network 115 to the portable communication device 101, which will be received by the data collection module 107. In response to that signal, the data collection module can transmit a second signal to the second apparatus 114, which in this embodiment is the remote medication dispensing system 1101. That signal can initiate the dispensing of medication from the dispensing system 1101.

Referring now to FIG. 12, the medication dispensing and monitoring systems are illustrated in further detail. Patient 1103 wears the data collection module 107, which in this embodiment can be configured for comfortable and discreet wear by a patient underneath the patient's clothing. The data collection module 107 is in communication with the patient's cellular phone 101. Data collection module 107 is in communication with the monitoring apparatus 1102 and the medication dispensing apparatus 1103. This embodiment of the present invention thereby allows a patient 1103 to plug his cellular phone 101 into a comfortably-worn and discrete apparatus comprising the data collection module 107, transmit a medical characteristic to a remotely-located doctor, and receive a signal from the doctor for the transmission of medication based on the characteristic.

There are a plurality of other useful systems embodying the present invention. For example, apparatus 114 can be a turbine, press, assembly line or other factory apparatus, the characteristic of which can be the speed or temperature of the apparatus. A sensing device such as a laser or switch can be used to measure the speed, and data representing that speed characteristic is received by data collection module 107. A factory inspector or other worker can place data collection module 107 in communication with the factory apparatus 114, and can use a cellular phone or other portable communication device 101 to transmit a message to a remote base station 121, which in this embodiment can be a computer located in a factory supervisor's office. The supervisor can then use the remote base station computer 121 to transmit a signal to the data collection module, via the established wireless network 115 and the portable communication device 121. In response to that signal, the data collection module 107 can transmit a second signal to the factory apparatus 114. This embodiment allows for an engineer or factory supervisor located remotely from the factory apparatus to monitor factory equipment and remotely control the factory equipment.

Another embodiment of the present invention is a data collection module for use in a vending machine apparatus. One characteristic of the vending machine is the amount of money received by the machine, which can be measured optically, using a laser to count the number of bills and/or coins received by the machine. The amount of money received by the machine apparatus can also be measured according to the weight of the received bills and/or coins. A data collection module 107 installed within the vending machine, or placed in communication therewith, can receive data from the machine representing that characteristic, and can transmit a message, via a portable communication device 101, to a remote base station 121. In this embodiment, the remote base station 121 is a computer of a supervisor of the vending machine. The supervisor of the vending machine can thereby receive a message indicating how much money has been collected by the vending machine, and that amount can be compared to the money received from collection workers charged with the responsibility of collecting money from the machine. The supervisor can thereby assure the accuracy of the collections. This embodiment also provides the supervisor with knowledge indicating that the vending machine's collection compartment is full and needs to be emptied.

While the specific embodiments have been illustrated and described, numerous modifications come to mind without significantly departing from the spirit of the invention, and the scope of protection is only limited by the scope of the accompanying Claims.

What is claimed is:

1. An interface system for communication between an apparatus and a remote base station using an established wireless network, the system comprising:
a data collection module configured to receive data relating to a characteristic of the apparatus, the data collection module comprising:
a port connected to the data collection module for coupling the data collection module to a portable communication device configured for wireless communication over the established wireless network; and,
a controller in the data collection module configured to transmit a message in response to the received data, wherein the message is transmitted to the remote base station via the port and portable communication device.

2. The system of claim 1, wherein the portable communication device is a cellular phone.

3. The system of claim 1, wherein the portable communication device is configured to establish communication with the remote base station, via the established wireless network, according to a predetermined time interval.

4. The system of claim 1, wherein the portable communication device is configured to receive a signal from a second remote location, and in response thereto, establish communication with the remote base station via the established wireless network.

5. The system of claim 4, wherein the signal received from the second remote location is a predetermined code.

6. The system of claim 1, wherein the data collection module is configured to receive a first signal from the remote base station, via the port and portable communication device, and in response thereto, transmit a second signal to the apparatus.

7. The system of claim 6, wherein the apparatus has a plurality of states, and wherein the second signal is for changing the state of the apparatus.

8. The system of claim 1, further comprising a port connected to the data collection module for coupling the data collection module with the apparatus.

9. The system of claim 1, wherein the message comprises data representative of a characteristic of the apparatus.

10. The system of claim 1, wherein the data collection module further comprises an activator for activating a solenoid, wherein the solenoid is for executing a functionality of the portable communication device.

11. The system of claim 1, wherein the data collection module further comprises an indicator for indicating a status of at least one of the data collection module, the apparatus, the portable communication device and the established wireless network.

12. A method for communicating between an apparatus and a remote base station using an established wireless network, the method comprising the steps of:
receiving data relating to a characteristic of the apparatus at a data collection module; and,
in response to receiving the data, transmitting a message from the data collection module to the remote base station via a portable communication device configured for wireless communication over the established wireless network.

13. The method of claim 12, wherein the portable communication device is a cellular phone.

14. The method of claim 12, further comprising the step of:
establishing communication between the portable communication device and the remote base station, via the established wireless network, according to a predetermined time interval.

15. The method of claim 12, further comprising the steps of:
receiving a signal at the portable communication device from a second remote location; and,
in response to receiving the signal, establishing communication with the remote base station.

16. The method of claim 15, wherein the signal received from the second remote location is a predetermined code.

17. The system of claim 12, further comprising the steps of:
receiving a first signal at the data collection module from the remote base station, via the portable communication device; and,
in response to receiving the first signal, transmitting a second signal from the data collection module to the apparatus.

18. The system of claim 17, wherein the apparatus has a plurality of states, and wherein the second signal is for changing the state of the apparatus.

19. The method of claim 12, wherein the message comprises data representative of a characteristic of the apparatus.

20. The method of claim 12, further comprising the step of:
indicating a status of at least one of the data collection module, the apparatus, the portable communication device and the established wireless network.
